(19) United States
(12) Patent Application Publication
(10) Pub. No.: US 2022/0129768 A1
(43) Pub. Date: Apr. 28, 2022

(54) METHOD AND APPARATUS FOR TRAINING MODEL, AND METHOD AND APPARATUS FOR PREDICTING TEXT

(71) Applicant: Beijing Baidu Netcom Science Technology Co., Ltd., Beijing (CN)

(72) Inventors: Dongling XIAO, Beijing (CN); Yukun LI, Beijing (CN); Han ZHANG, Beijing (CN); Yu SUN, Beijing (CN); Hao TIAN, Beijing (CN); Hua WU, Beijing (CN); Haifeng WANG, Beijing (CN)

(21) Appl. No.: 17/646,851

(22) Filed: Jan. 3, 2022

(30) Foreign Application Priority Data
Jun. 30, 2021 (CN) 202110738146.6

(51) Int. Cl. G06N 5/02

(52) U.S. Cl. CPC G06N 5/022

(57) ABSTRACT

The present disclosure provides a method and apparatus for training a model. The method can include: acquiring at least one paragraph text, each paragraph text comprising a plurality of fine-grained samples; processing a fine-grained sample in the each paragraph text to obtain a coarse-grained sample; annotating the coarse-grained sample in the each paragraph text and obscuring one coarse-grained sample using a mask of one fine-grained sample to obtain a training sample set, wherein the training sample set comprises a plurality of annotated texts, and each annotated text comprises at least one of a fine-grained sample or an annotated coarse-grained sample; and training a fine-grained model using the training sample set to obtain a trained fine-grained model, the fine-grained model being used to learn content of a previous fine grain size and predict content of an adjacent coarse grain size.

### CROSS-REFERENCE TO RELATED APPLICATIONS

This application claims priority to Chinese Patent Application No. 202110738146.6, filed with the China National Intellectual Property Administration (CNIPA) on Jun. 30, 2021, the contents of which are incorporated herein by reference in their entirety.

### TECHNICAL FIELD

The present disclosure relates to the field of computer technology, specifically to the fields of natural language processing, deep learning and other technologies, and particularly to a method and apparatus for training a model, a method and apparatus for predicting a text, an electronic device, a computer readable medium and a computer program product.

### BACKGROUND

In a masked language modeling (MLM), different mask positions are independent of each other. For a model using a continuous masking approach, for example, an ERNIE (Enhanced Representation from Knowledge Integration) and a BERT-wwm (Bidirectional Encoder Representation from Transformers-Whole Word Masking), the predictions of the model for the characters contained in one consecutive expression are independent of each other. Accordingly, a combination mode of several characters can only be remembered by training the masked language model, and the semantic meaning of the consecutive expression itself cannot be well learned, and thus, the semantic closeness of the consecutive expression is not high.

### SUMMARY

A method and apparatus for training a model, a method and apparatus for predicting a text, an electronic device, a computer readable medium and a computer program product are provided.

In a first aspect, embodiments of the present disclosure provide a method for training a model, comprising: acquiring at least one paragraph text, each paragraph text comprising a plurality of fine-grained samples; processing a fine-grained sample in the each paragraph text to obtain a coarse-grained sample; annotating the coarse-grained sample in the each paragraph text and obscuring one coarse-grained sample using a mask of one fine-grained sample to obtain a training sample set, wherein the training sample set comprises a plurality of annotated texts, and each annotated text comprises at least one of a fine-grained sample or an annotated coarse-grained sample; and training a fine-grained model using the training sample set to obtain a trained fine-grained model, the fine-grained model being used to learn content of a previous fine grain size and predict content of an adjacent coarse grain size.

In a second aspect, embodiments of the present disclosure provide a method for predicting a text, comprising: acquiring a to-be-predicted text; and inputting the to-be-predicted text into the fine-grained model generated through the method according to the first aspect, to obtain a coarse grain size in the to-be-predicted text and a type of the coarse grain size.

In a third aspect, embodiments of the present disclosure provide an apparatus for training a model, comprising: a sample acquiring unit, configured to acquire at least one paragraph text, each paragraph text comprising a plurality of fine-grained samples; a processing unit, configured to process a fine-grained sample in the each paragraph text to obtain a coarse-grained sample; an obtaining unit, configured to annotate the coarse-grained sample in the each paragraph text and obscure one coarse-grained sample using a mask of one fine-grained sample to obtain a training sample set, wherein the training sample set comprises a plurality of annotated texts, and each annotated text comprises at least one of a fine-grained sample or an annotated coarse-grained sample; and a training unit, configured to train a fine-grained model using the training sample set to obtain a trained fine-grained model, the fine-grained model being used to learn content of a previous fine grain size and predict content of an adjacent coarse grain size.

In a fourth aspect, embodiments of the present disclosure provide an apparatus for predicting a text, comprising: an acquiring unit, configured to acquire a to-be-predicted text; and an obtaining unit, configured to input the to-be-predicted text into the fine-grained model generated through the method according to the first aspect, to obtain a coarse grain size in the to-be-predicted text and a type of the coarse grain size.

In a fifth aspect, embodiments of the present disclosure provide an electronic device, comprising: one or more processors; and a memory, storing one or more programs, wherein the one or more programs, when executed by the one or more processors, cause the one or more processors to implement the method provided by the first aspect or the second aspect.

In a sixth aspect, embodiments of the present disclosure provide a computer-readable medium, storing a computer program thereon, wherein the program, when executed by a processor, causes the processor to implement the method provided by the first aspect or the second aspect.

In a seventh aspect, an embodiment of the present disclosure provides a computer program product, comprising a computer program, wherein the computer program, when executed by a processor, implements the method provided by the first aspect or the second aspect.

According to the method and apparatus for training a model provided in the embodiments of the present disclosure, the at least one paragraph text is first acquired, the each paragraph text including the plurality of fine-grained samples. Then, the fine-grained sample in the each paragraph text is processed to obtain the coarse-grained sample. Next, the coarse-grained sample in the each paragraph text is annotated and the one coarse-grained sample is obscured using the mask of the one fine-grained sample to obtain the training sample set. Finally, the fine-grained model is trained using the training sample set to obtain the trained fine-grained model. The fine-grained model is used to learn the content of the previous fine grain size and predict the content of the adjacent coarse grain size. Accordingly, using the mask of the one fine-grained sample to obscure the one coarse-grained sample is equivalent to using the coarse grain size as one fine grain size. When the model is trained, the complete representation of the coarse grain size can be obtained by only predicting the coarse-grained sample once, and the prediction is not the prediction for all the fine grain sizes in the coarse grain size, which is conducive to the convergence of the fine-grained model. Therefore, the model can effectively learn the overall semantic meaning of the coarse grain size while the amount of calculation of the model is saved.

According to the method and apparatus for predicting a text provided in the embodiments of the present disclosure, the to-be-predicted text is acquired, and the to-be-predicted text is inputted into the fine-grained model generated using the method for training a model in the embodiments, to obtain the coarse grain size in the to-be-predicted text and the type of the coarse grain size. Accordingly, the fine-grained model may distinguish a plurality of fine grain sizes according to a coarse grain size, and may also distinguish a coarse grain size as a whole, which is helpful in learning the semantic meaning of the coarse grain size itself.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a flowchart of an embodiment of a method for training a model according to the present disclosure;

FIG. 2 is a schematic structural diagram of training for a fine-grained model in an embodiment of the present disclosure;

FIG. 3 is a flowchart of an embodiment of a method for predicting a text according to the present disclosure.

FIG. 4 is a schematic structural diagram of an embodiment of an apparatus for training a model according to the present disclosure;

FIG. 5 is a schematic structural diagram of an embodiment of an apparatus for predicting a text according to the present disclosure; and

FIG. 6 is a block diagram of an electronic device used to implement a method for training a model or a method for predicting a text according to embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

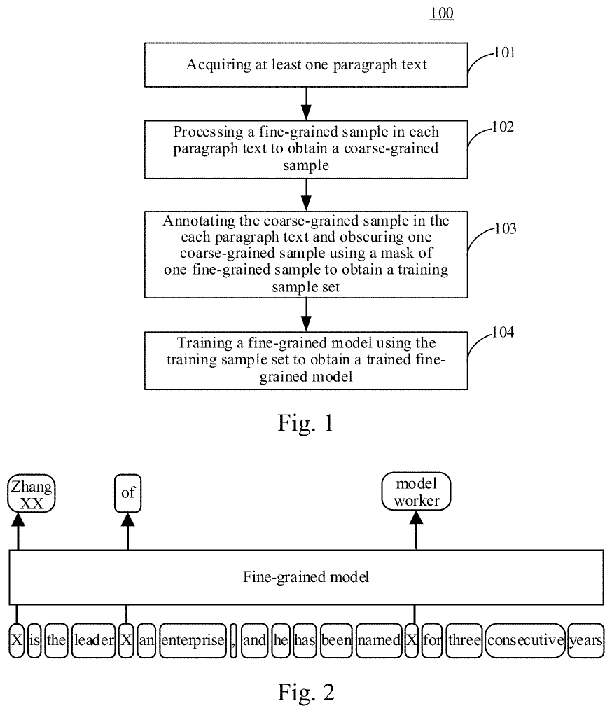

FIG. 1 illustrates a flow 100 of an embodiment of a method for training a model according to the present disclosure. The above method for training a model includes the following steps:

Step 101, acquiring at least one paragraph text.

Here, each paragraph text includes a plurality of fine-grained samples.

In this embodiment, an executing body on which the method for training a model runs may acquire the paragraph text by various means, for example, may acquire the paragraph text from a terminal in real time, or select, from a data storage library, a plurality of texts as the paragraph text.

In this embodiment, the paragraph text takes a fine grain size as a minimum unit, and fine grain sizes may be combined into a coarse grain size. A fine-grained model generated through the method for training a model provided in this embodiment may predict a fine grain size in a to-be-predicted text. Alternatively, the fine-grained model may also predict the fine grain size in the to-be-predicted text and a coarse grain size other than the predicted fine grain size obtained through the prediction.

In this embodiment, the fine grain size and the coarse grain size are relative concepts, and if the defined content of the fine grain size is different, the coarse grain size is correspondingly different. As an example, if the fine grain size refers to a character, the coarse grain size may be a word, a term, or the like. As another example, if the fine grain size refers to a term, the coarse grain size may be a short sentence, a text fragment, or the like.

In this embodiment, in order to implement the training for the fine-grained model, it is required to process the fine grain size to obtain a fine-grained sample, and process the coarse grain size to obtain a coarse-grained sample. The fine-grained sample and the coarse-grained sample are the samples that can be recognized by the constructed fine-grained model. The fine-grained sample and the coarse-grained sample may be only the fine grain size and the coarse grain size, and the fine-grained sample and the coarse-grained sample may also include the meanings, structures, positions, vectors, types and other information of the fine grain size and the coarse grain size.

Step 102, processing a fine-grained sample in each paragraph text to obtain a coarse-grained sample.

In this embodiment, in the situation where a whole paragraph of text takes the fine grain size as the minimum unit, in order to implement the prediction for the coarse grain size, it is required to combine the fine grain size to obtain the coarse grain size. When a training sample set of the fine-grained model is acquired, it is required to fully mine the coarse-grained sample in the paragraph text such that the fine-grained model may predict the content of the coarse-grained sample on the basis of learning the content of the fine-grained sample.

In this embodiment, as the fine-grained sample defined is different, the coarse-grained sample obtained through the combination may also be different. For example, when the fine-grained sample refers to a word sample, the coarse-grained sample may be a term sample or an entity sample. When the fine-grained sample refers to a term sample, the coarse-grained sample may be a phrase sample.

Step 103, annotating the coarse-grained sample in the each paragraph text and obscuring one coarse-grained sample using a mask of one fine-grained sample to obtain a training sample set.

Here, the training sample set includes a plurality of annotated texts, and each annotated text includes at least one of a fine-grained sample or an annotated coarse-grained sample.

In this embodiment, an annotated text corresponds to a paragraph text, and the annotated text is obtained by annotating the paragraph text and through the mask. The relationship between the fine-grained sample and the annotated coarse-grained sample in each annotated text may refer to an adjacent arrangement or a spaced arrangement (as shown in FIG. 2). Alternatively, the annotated text may also include an annotated fine-grained sample, and the annotated fine-grained sample is obscured by the mask of the fine grain size and annotated with the content of the fine grain size. It should be noted that the annotated coarse-grained sample includes a coarse-grained sample and annotation information of the coarse-grained sample. A parameter adjustment may be performed on the fine-grained model through the annotation information of the coarse-grained sample.

In this embodiment, before a traditional fine-grained model is trained, a to-be-predicted fine-grained sample is first obscured by the mask of the fine-grained sample, that is, the to-be-predicted fine-grained sample is shielded. The parameter of the fine-grained model is adjusted through the prediction of the fine-grained model for the shielded fine-grained sample, until the prediction result of the fine-grained model for the to-be-predicted fine-grained sample reaches a requirement. In this embodiment, as shown in FIG. 2, the obtained coarse-grained sample is shielded using the mask X of the fine-grained sample, such that the fine-grained model performs an overall prediction on the coarse grain size, to obtain a prediction result of the coarse grain size (the result being represented by the fine grain size).

In this embodiment, one coarse-grained sample is obscured using the mask of a single fine-grained sample. Accordingly, for each obscured coarse-grained sample, the complete representation of the coarse-grained sample (the prediction result of the coarse grain size) can be obtained through only one prediction, rather than a prediction for representations of all the fine grain sizes in the coarse grain size.

Alternatively, when the one coarse-grained sample is obscured using the mask of the one fine-grained sample, one fine-grained sample (e.g., “of” in FIG. 2) may also be obscured using the mask of the fine-grained sample, and thus the obtained training sample set may include the fine-grained sample, the annotated coarse-grained sample and the annotated fine-grained sample.

Step 104, training a fine-grained model using the training sample set to obtain a trained fine-grained model.

Here, the fine-grained model is used to learn content of a previous fine grain size and predict content of an adjacent coarse grain size. In this embodiment, the coarse grain size is obtained by combining one or more fine grain sizes. The fine-grained model may learn the previous fine grain size adjacent to the coarse grain size in the paragraph text, and give a prediction result for the coarse grain size. The prediction result is the content of the coarse grain size, and the content of the coarse grain size is related to the content of the fine grain size that is learned by the model. When the fine-grained model learns the type, meaning, structure, position, vector and other information of the fine grain size, the content of the predicted coarse grain size may also be the type, meaning, structure, position, vector and other information of the coarse grain size.

In this embodiment, the fine-grained model is a masked language model, and the masked language model may include a context-independent semantic representation model Word2Vec (word vector correlation model), a Glove, etc., or include a context-dependent semantic representation Elmo (Deep contextualized word representation), a BERT (Bidirectional Encoder Representation from Transformers), etc.

Specifically, the training a fine-grained model using the training sample set to obtain a trained fine-grained model includes the following step:

A fine-grained network is constructed using a structure of the above model, and the fine-grained network is trained using the training sample set. During the training, an error of the fine-grained network may be determined according to a difference between a prediction result of the fine-grained network for a coarse-grained sample in a training sample in the training sample set and annotation information of a coarse grain size of the training sample in the training sample set. The parameter of the fine-grained network is iteratively adjusted by means of an error back propagation, and thus, the error of the fine-grained network is gradually reduced. When the error of the fine-grained network converges to a certain range or the number of iterations reaches a preset number threshold, the adjustment for the parameter can be stopped, thus obtaining the trained fine-grained model.

Alternatively, the training a fine-grained model using the training sample set to obtain a trained fine-grained model may also include the following step:

A fine-grained network is constructed using a structure of the above model, and the fine-grained network is trained using the training sample set. During the training, according to a first difference between a prediction result of the fine-grained network for a fine-grained sample in a training sample in the training sample set and annotation information of a fine grain size of the training sample in the training sample set and a second difference between a prediction result of the fine-grained network for a coarse-grained sample in a training sample in the training sample set and annotation information of a coarse grain size of the training sample in the training sample set, an error of the fine-grained network may be determined from the sum of the first difference and the second difference. The parameter of the fine-grained network is iteratively adjusted by means of an error back propagation, and thus, the error of the fine-grained network is gradually reduced. When the error of the fine-grained network converges to a certain range or the number of iterations reaches a preset number threshold, the adjustment for the parameter can be stopped, thus obtaining the trained fine-grained model.

As an example, for the place entity “Heilongjiang,” a prediction formula using a continuous masking approach of a traditional fine-grained model is P (“Hei”|context) P (“long”|context) P (“jiang”|context), a dictionary size is 3e⁴, and a candidate space size predicted through the prediction formula is (3e⁴)³=3e¹². Accordingly, the numerical values are very large and sparse, and thus, the dependency and correlation the characters in the word cannot be sufficiently modeled, which is not conducive to modeling the complete semantic meaning of the word itself.

By using the trained fine-grained model in this embodiment, the prediction probability of the coarse grain size “Heilongjiang” is P (“Heilongjiang”|context). The dictionary size of the coarse grain size is 3e⁶, and the prediction space of the model is 3e⁶<<3e¹². Accordingly, the prediction space of the coarse grain size becomes smaller and denser, which is conducive to the learning of the semantic meaning of the coarse grain size itself and to the convergence of the fine-grained model.

According to the method for training a model provided in the embodiment of the present disclosure, the at least one paragraph text is first acquired, the each paragraph text including the plurality of fine-grained samples. Then, the fine-grained sample in the each paragraph text is processed to obtain the coarse-grained sample. Next, the coarse-grained sample in the each paragraph text is annotated and the one coarse-grained sample is obscured using the mask of the one fine-grained sample to obtain the training sample set. Finally, the fine-grained model is trained using the training sample set to obtain the trained fine-grained model. The fine-grained model is used to learn the content of the previous fine grain size and predict the content of the adjacent coarse grain size. Accordingly, using the mask of the one fine-grained sample to obscure the one coarse-grained sample is equivalent to using the coarse grain size as one fine grain size. When the model is trained, the complete representation of the coarse grain size can be obtained by only predicting the coarse-grained sample once, and the prediction is not the prediction for all the fine grain sizes in the coarse grain size, which is conducive to the convergence of the fine-grained model. Therefore, the model can effectively learn the overall semantic meaning of the coarse grain size while the amount of calculation of the model is saved.

In some alternative implementations of this embodiment, the above fine-grained sample refers to a word sample, and the coarse-grained sample includes a term sample or an entity sample. The processing a fine-grained sample in each paragraph text to obtain a coarse-grained sample includes: acquiring semantic meanings of all word samples in the each paragraph text; detecting, based on a semantic meaning of each word sample, whether at least two adjacent word samples in a current paragraph text conform to a term combination rule or an entity naming rule; and combining, in response to detecting that a combination of the at least two adjacent word samples conforms to the term combination rule or the entity naming rule, all word samples conforming to the term combination rule or the entity naming rule to obtain the term sample or the entity sample.

Specifically, as shown in FIG. 2, the fine-grained model performs a prediction on the paragraph text “X is the leader X an enterprise, and he has been named X for three consecutive years,” to obtain a prediction result for a word (e.g., “of” in FIG. 2) in the paragraph text and a prediction result for a term (e.g., “model worker” in FIG. 2) or entity (e.g., “Zhang XX” in FIG. 2) in the paragraph text.

In FIG. 2, the coarse grain size is obscured using the mask X of the fine grain size, and the overall prediction of the fine-grained model for the coarse grain size is implemented, thus obtaining the prediction results of the coarse grain size and the fine grain size.

In this alternative implementation, at least two words may constitute a term or an entity, the term including a word, a word group and a whole expression. The fine-grained sample is the minimum unit constituting a paragraph text. When the fine-grained sample refers to the word sample, in order to determine the term sample and entity sample in the paragraph text, it is required to acquire the semantic meaning of each word, to determine whether a term sample may be obtained by combining at least two adjacent word samples or whether the at least two adjacent word samples satisfy an entity naming requirement, and the word samples satisfying the entity naming requirement are combined together to obtain the entity sample. In this embodiment, the term rule includes: acquiring the semantic meaning of the each word to determine whether the term sample may be obtained by combining the at least two adjacent word samples. The entity naming rule includes: acquiring the semantic meaning of the each word to determine whether the at least two adjacent word samples satisfy the entity naming requirement, and combining, if the entity naming requirement is satisfied, the word samples satisfying the entity naming requirement together to obtain the entity sample.

In this alternative implementation, when the fine-grained sample refers to the word sample, a word sample satisfying the term rule or the entity naming rule is selected, such that the coarse-grained sample is the term sample or the entity sample. Thus, the trained fine-grained model can predict the content of a term or entity in a text in units of words.

In some alternative implementations of this embodiment, the above fine-grained sample refers to the word sample, and the coarse-grained sample further includes a phrase sample. The processing a fine-grained sample in each paragraph text to obtain a coarse-grained sample further includes: detecting, based on the semantic meaning of the each word sample and a structure of the each word sample, whether all word samples in the current paragraph text conform to a phrase combination rule; and combining, in response to detecting that a word sample in the current paragraph text conforms to the phrase combination rule, all word samples conforming to the phrase combination rule to obtain the phrase sample.

In this alternative implementation, the phrase sample may be constituted by at least one term sample or entity sample based on the structure of the term sample or entity sample. The phrase combination rule includes: acquiring a word sample or entity sample satisfying the term combination rule and the entity naming rule; determining, based on a structure of a word sample in each term sample or entity sample, a structure of the each term sample or entity sample; and combining, when at least two adjacent term samples or entity samples have a feature such as symmetry and similarity, the at least two adjacent term samples or entity samples to obtain the phrase sample.

In this alternative implementation, the term sample or entity sample is constituted based on the word sample, and on this basis, the phrase sample is further constituted, which provides a reliable sample basis for the fine-grained model to recognize various coarse grain sizes, thereby ensuring the reliability of the recognition of the fine-grained model.

Alternatively, the above fine-grained sample refers to the word sample, and the coarse-grained sample further includes the phrase sample. The processing a fine-grained sample in each paragraph text to obtain a coarse-grained sample further includes: detecting whether all term samples or entity samples in the current paragraph text conform to the phrase combination rule; and combining, in response to detecting that a term sample or entity sample in the current paragraph text conforms to the phrase combination rule, all term samples or entity samples conforming to the phrase combination rule to obtain the phrase sample.

In some alternative implementations of this embodiment, the above fine-grained sample includes a term sample or an entity sample, and the coarse-grained sample includes a phrase sample. The processing a fine-grained sample in each paragraph text to obtain a coarse-grained sample further includes: acquiring semantic meanings and structures of all term samples or entity samples in the each paragraph text; detecting, based on a semantic meaning and structure of each term sample or entity sample, whether at least two adjacent term samples or entity samples in the current paragraph text conform to the phrase combination rule; and combining, in response to detecting that the at least two adjacent term samples or entity samples in the current paragraph text conform to the phrase combination rule, all term samples or entity samples conforming to the phrase combination rule to obtain the phrase sample.

In this alternative implementation, based on the term samples or entity samples, the phrase sample is obtained by combining the term samples or entity samples, which provides a reliable sample basis for the fine-grained model to recognize various coarse grain sizes, thereby ensuring the reliability of the recognition of the fine-grained model.

In some alternative implementations of this embodiment, the above fine-grained sample refers to a word sample, and the coarse-grained sample includes a phrase sample. The processing a fine-grained sample in each paragraph text to obtain a coarse-grained sample further includes: acquiring the semantic meanings of the all word samples in the each paragraph text and structures of the all word samples; detecting, based on the semantic meaning of the each word sample and the structure of the each word sample, whether a preset number of adjacent word samples in the current paragraph text conform to the phrase combination rule in sequence; and combining, in response to detecting that a plurality of word samples conforming to the phrase combination rule are present in the preset number of adjacent word samples in the current paragraph text, the plurality of word samples conforming to the phrase combination rule to obtain the phrase sample.

In this alternative implementation, based on the word samples, the phrase sample is obtained by combining the word samples, which provides a reliable sample basis for the fine-grained model to recognize various coarse grain sizes, thereby ensuring the reliability of the recognition of the fine-grained model.

In some alternative implementations of this embodiment, annotating the coarse-grained sample in the each paragraph text and obscuring one coarse-grained sample using a mask of one fine-grained sample to obtain the training sample set includes: annotating content and a type of the coarse-grained sample in the each paragraph text; obscuring the coarse-grained sample in the each paragraph text using a mask of a fine-grained sample corresponding to the fine-grained model, to obtain an annotated coarse-grained sample; and sorting all fine-grained samples and all annotated coarse-grained samples according to an order of each fine-grained sample in a paragraph text of the each fine-grained sample and an order of each coarse-grained sample in a paragraph text of the each coarse-grained sample, to obtain the training sample set.

In an alternative implementation of this embodiment, the content of the coarse-grained sample is the coarse grain size itself, and the type of the coarse-grained sample may be the field, industry or category to which the coarse-grained sample belongs. For example, if a coarse-grained sample is “tall building,” the type of the coarse-grain size is architectonics.

In this alternative implementation, the all fine-grained samples and the all annotated coarse-grained samples are sorted according to the order of the each fine-grained sample in the paragraph text of the each fine-grained sample and the order of the each coarse-grained sample in the paragraph text of the each coarse-grained sample. After the training sample set is inputted into the fine-grained model, the fine-grained model may predict and obtained the content of the coarse grain size by analyzing the content of the each fine-grained sample, which facilitates the convergence of the fine-grained model.

In this alternative implementation, after the content and type of the coarse grain size are annotated, the coarse-grained sample is obscured using the mask and the each fine grain size and the each coarse grain size are sorted in sequence in the each paragraph text, which provides a reliable basis for the fine-grained model to better learn the content of the fine grain size and the content of the coarse grain size, thereby ensuring the accuracy of the training for the fine-grained model.

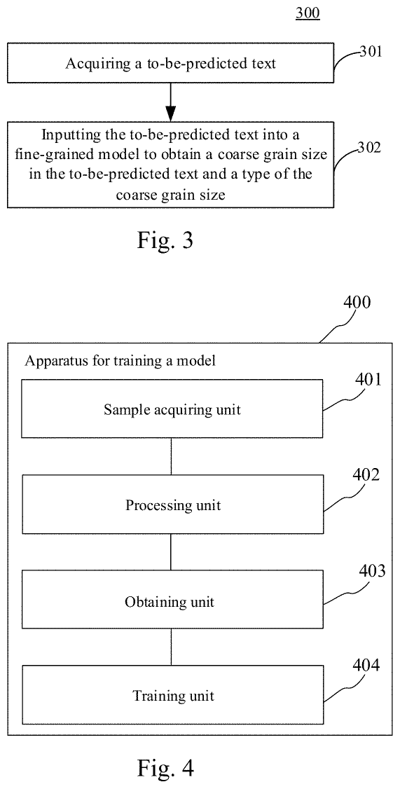

FIG. 3 illustrates a flow 300 of an embodiment according to a method for predicting a text. The above method for predicting a text includes the following steps:

Step 301, acquiring a to-be-predicted text.

In this embodiment, the to-be-predicted text may include a text in at least one different format. A text takes a fine grain size as a minimum unit, and a coarse grain size is a unit obtained by combining fine grain sizes. A fine-grained model generated through the method for training a model provided in the above embodiment may predict the content of the coarse grain size other than the fine grain size in the to-be-predicted text. Alternatively, the fine-grained model may also predict both the fine grain size and the coarse grain size in the to-be-predicted text.

In this embodiment, in a paragraph text, the coarse grain size may be obtained by combining the fine grain sizes. A text in a plurality of different formats means that the formats of a coarse grain size and a fine grain size that constitute a paragraph text are different. For example, a fine grain size that may be recognized from a paragraph text in a format is a word, and a coarse grain size that may be recognized from the paragraph text is a phrase. A fine grain size that may be recognized from a paragraph text in an other format is a term, and a coarse grain size that may be recognized from the paragraph text is a phrase.

In this embodiment, the fine grain size may include: a character, a word, a term, a phrases, a short sentence, a numerical digit, and the like, and correspondingly, the coarse grain size may include a term, a phrases, a short sentence, and the like.

Step 302, inputting the to-be-predicted text into a fine-grained model to obtain a coarse grain size in the to-be-predicted text and a type of the coarse grain size.

In this embodiment, the fine-grained model, after being trained, may give the content and type of the coarse grain size in the text according to the text. The content of the coarse grain size may be from the to-be-predicted text. Specifically, the fine-grained model may use the fine-grained model trained and generated through steps 101-104.

In this embodiment, the fine-grained model may be generated using the method described in the above embodiment of FIG. 1. For the specific generation process, reference may be made to the related description in the embodiment of FIG. 1, which will not be repeatedly described here.

It should be noted that the method for predicting a text in this embodiment may be used to test the fine-grained model generated in the above embodiments. Then, the fine-grained model may be continuously optimized according to a transformation result. The method may also be an actual application method of the fine-grained model generated in the above embodiments. Using the fine-grained model generated in the above embodiments to predict the to-be-predicted text is helpful in improving the accuracy of the obtained prediction result.

According to the method for predicting a text provided in the embodiment of the present disclosure, the to-be-predicted text is acquired, and the to-be-predicted text is inputted into the fine-grained model generated using the method for training a model in the above embodiment, to obtain the coarse grain size in the to-be-predicted text and the type of the coarse grain size. Accordingly, the fine-grained model may distinguish a plurality of fine grain sizes according to a coarse grain size, and may also distinguish a coarse grain size as a whole, which is helpful in learning the semantic meaning of the coarse grain size itself.

Further referring to FIG. 4, as an implementation of the method shown in the above drawings, the present disclosure provides an embodiment of an apparatus for training a model. The embodiment of the apparatus corresponds to the embodiment of the method shown in FIG. 1, and the apparatus may be applied in various electronic devices.

As shown in FIG. 4, the apparatus 400 for training a model provided in this embodiment includes: a sample acquiring unit 401, a processing unit 402, an obtaining unit 403 and a training unit 404. Here, the sample acquiring unit 401 may be configured to acquire at least one paragraph text, each paragraph text comprising a plurality of fine-grained samples. The processing unit 402 may be configured to process a fine-grained sample in the each paragraph text to obtain a coarse-grained sample. The obtaining unit 403 may be configured to annotate the coarse-grained sample in the each paragraph text and obscure one coarse-grained sample using a mask of one fine-grained sample to obtain a training sample set. The training sample set includes a plurality of annotated texts, and each annotated text includes at least one of a fine-grained sample or an annotated coarse-grained sample. The training unit 404 may be configured to train a fine-grained model using the training sample set to obtain a trained fine-grained model. The fine-grained model is used to learn content of a previous fine grain size and predict content of an adjacent coarse grain size.

In this embodiment, for specific processes of the sample acquiring unit 401, the processing unit 402, the obtaining unit 403 and the training unit 404 in the apparatus 400 for training a model, and their technical effects, reference may be respectively made to relative descriptions of step 101, step 102, step 103 and step 104 in the corresponding embodiment of FIG. 1, which will not be repeatedly described here.

In some alternative implementations of this embodiment, the fine-grained sample refers to a word sample, and the coarse-grained sample includes a term sample or an entity sample. The above processing unit 402 includes: a word semantic meaning acquiring module (not shown), a word detecting module (not shown) and a term combining module (not shown). Here, the word semantic meaning acquiring module may be configured to acquire semantic meanings of all word samples in the each paragraph text. The word detecting module may be configured to detect, based on a semantic meaning of each word sample, whether at least two adjacent word samples in a current paragraph text conform to a term combination rule or an entity naming rule. The term combining module may be configured to combine, in response to detecting that a combination of the at least two adjacent word samples conforms to the term combination rule or the entity naming rule, all word samples conforming to the term combination rule or the entity naming rule to obtain the term sample or the entity sample.

In some alternative implementations of this embodiment, the processing unit 402 further includes: a first phrase detecting module (not shown) and a first phrase combining module (not shown). Here, the first phrase detecting module may be configured to detect, based on the semantic meaning of the each word sample and a structure of the each word sample, whether all word samples in the current paragraph text conform to a phrase combination rule. The first phrase combining module may be configured to combine, in response to detecting that a word sample in the current paragraph text conforms to the phrase combination rule, all word samples conforming to the phrase combination rule to obtain a phrase sample.

In some alternative implementations of this embodiment, the fine-grained sample includes a term sample or an entity sample, and the coarse-grained sample includes a phrase sample. The processing unit 402 includes: a term semantic meaning acquiring module (not shown), a second phrase detecting module (not shown) and a second phrase combining module (not shown). Here, the term semantic meaning acquiring module may be configured to acquire acquiring semantic meanings and structures of all term samples or entity samples in the each paragraph text. The second phrase detecting module may be configured to detect, based on a semantic meaning and structure of each term sample or entity sample, whether at least two adjacent term samples or entity samples in the current paragraph text conform to the phrase combination rule. The second phrase combining module may be configured to combine, in response to detecting that the at least two adjacent term samples or entity samples in the current paragraph text conform to the phrase combination rule, all term samples or entity samples conforming to the phrase combination rule to obtain the phrase sample.

In some alternative implementations of this embodiment, the fine-grained sample refers to a word sample, and the coarse-grained sample comprises a phrase sample. The processing unit includes: a word structure acquiring module (not shown), a third phrase detecting module (not shown) and a third phrase combining module (not shown). Here, the word structure acquiring module may be configured to acquire the semantic meanings of the all word samples in the each paragraph text and structures of the all word samples. The third phrase detecting module may be configured to detect, based on the semantic meaning of the each word sample and the structure of the each word sample, whether a preset number of adjacent word samples in the current paragraph text conform to the phrase combination rule in sequence. The third phrase combining module may be configured to combine, in response to detecting that a plurality of word samples conforming to the phrase combination rule are present in the preset number of adjacent word samples in the current paragraph text, the plurality of word samples conforming to the phrase combination rule to obtain the phrase sample.

In some alternative implementations of this embodiment, the obtaining unit 403 includes: an annotating module (not shown), an obscuring module (not shown) and a sorting module (not shown). Here, the annotating module may be configured to annotate content and a type of the coarse-grained sample in the each paragraph text. The obscuring module may be configured to obscure the coarse-grained sample in the each paragraph text using a mask of a fine-grained sample corresponding to the fine-grained model, to obtain an annotated coarse-grained sample. The sorting module may be configured to sort all fine-grained samples and all annotated coarse-grained samples according to an order of each fine-grained sample in a paragraph text of the each fine-grained sample and an order of each coarse-grained sample in a paragraph text of the each coarse-grained sample, to obtain the training sample set

According to the apparatus for training a model provided in the embodiment of the present disclosure, first, the sample acquiring unit 401 acquires the at least one paragraph text, the each paragraph text including the plurality of fine-grained samples. Then, the processing unit 402 processes the fine-grained sample in the each paragraph text to obtain the coarse-grained sample. Next, the obtaining unit 403 annotates the coarse-grained sample in the each paragraph text and obscures the one coarse-grained sample using the mask of the one fine-grained sample to obtain the training sample set. Finally, the training unit 404 trains the fine-grained model using the training sample set to obtain the trained fine-grained model. The fine-grained model is used to learn the content of the previous fine grain size and predict the content of the adjacent coarse grain size. Accordingly, using the mask of the one fine-grained sample to obscure the one coarse-grained sample is equivalent to using the coarse grain size as one fine grain size. When the model is trained, the complete representation of the coarse grain size can be obtained by only predicting the coarse-grained sample once, and the prediction is not the prediction for all the fine grain sizes in the coarse grain size, which is conducive to the convergence of the fine-grained model. Therefore, the model can effectively learn the overall semantic meaning of the coarse grain size while the amount of calculation of the model is saved.

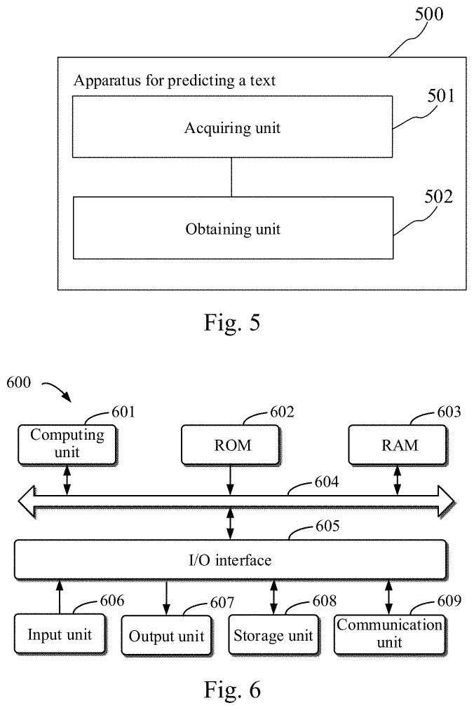

Further referring to FIG. 5, as an implementation of the method shown in the above drawings, the present disclosure provides an embodiment of an apparatus for predicting a text. The embodiment of the apparatus corresponds to the embodiment of the method shown in FIG. 3, and the apparatus may be applied in various electronic devices.

As shown in FIG. 6, the apparatus 600 for predicting a text provided in this embodiment includes: an acquiring unit 601 and an obtaining unit 602. Here, the acquiring unit may be configured to acquire a to-be-predicted text. The obtaining unit 602 may be configured to input the to-be-predicted text into the fine-grained model generated using the above method for training a model, to obtain a coarse grain size in the to-be-predicted text and a type of the coarse grain size.

In this embodiment, for specific processes of the acquiring unit 601 and the obtaining unit 602 in the apparatus 600 for predicting a text, and their technical effects, reference may be respectively made to relative descriptions of step 301 and step 302 in the corresponding embodiment of FIG. 3, which will not be repeatedly described here.

The acquisition, storage and application of personal information of users that are involved in the technical solution of the present disclosure are in compliance with relevant laws and regulations, and do not violate the public order and good morals.

According to an embodiment of the present disclosure, the present disclosure further provides an electronic device, a readable storage medium and a computer program product.

FIG. 6 is a schematic block diagram of an exemplary electronic device 600 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the device 600 includes a computation unit 601, which may execute various appropriate actions and processes in accordance with a computer program stored in a read-only memory (ROM) 602 or a computer program loaded into a random access memory (RAM) 603 from a storage unit 608. The RAM 603 also stores various programs and data required by operations of the device 600. The computation unit 601, the ROM 602 and the RAM 603 are connected to each other through a bus 604. An input/output (I/O) interface 605 is also connected to the bus 604.

The following components in the device 600 are connected to the I/O interface 605: an input unit 606, for example, a keyboard and a mouse; an output unit 607, for example, various types of displays and a speaker; a storage device 608, for example, a magnetic disk and an optical disk; and a communication unit 609, for example, a network card, a modem, a wireless communication transceiver. The communication unit 609 allows the device 600 to exchange information/data with an other device through a computer network such as the Internet and/or various telecommunication networks.

The computation unit 601 may be various general-purpose and/or special-purpose processing assemblies having processing and computing capabilities. Some examples of the computation unit 601 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 601 performs the various methods and processes described above, for example, the method for training a model or predicting a text. For example, in some embodiments, the method for training a model or predicting a text may be implemented as a computer software program, which is tangibly included in a machine readable medium, for example, the storage device 608. In some embodiments, part or all of the computer program may be loaded into and/or installed on the device 600 via the ROM 602 and/or the communication unit 609. When the computer program is loaded into the RAM 603 and executed by the computation unit 601, one or more steps of the above method for training a model or predicting a text may be performed. Alternatively, in other embodiments, the computation unit 601 may be configured to perform the method for training a model or predicting a text through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable model training apparatus or text predicting apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of some embodiments of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a distributed system server, or a server combined with a blockchain. The server may also be a cloud server, or an intelligent cloud computing server or an intelligent cloud client with artificial intelligence technology.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training a model, comprising:
acquiring at least one paragraph text, each paragraph text comprising a plurality of fine-grained samples;
processing a fine-grained sample in each paragraph text to obtain a coarse-grained sample;
annotating the coarse-grained sample in each paragraph text and obscuring one coarse-grained sample using a mask of one fine-grained sample to obtain a training sample set, wherein the training sample set comprises a plurality of annotated texts, and each annotated text comprises at least one of: a fine-grained sample or an annotated coarse-grained sample; and
training a fine-grained model using the training sample set to obtain a trained fine-grained model, the fine-grained model being used to learn content of a previous fine grain size and predict content of an adjacent coarse grain size.

2. The method according to claim 1, wherein the fine-grained sample refers to a word sample, the coarse-grained sample comprises a term sample or an entity sample, and processing the fine-grained sample in each paragraph text to obtain the coarse-grained sample comprises:
acquiring semantic meanings of all word samples in each paragraph text;
detecting, based on a semantic meaning of each word sample, whether at least two adjacent word samples in a current paragraph text conform to a term combination rule or an entity naming rule; and
combining, in response to detecting that a combination of the at least two adjacent word samples conforms to the term combination rule or the entity naming rule, all word samples conforming to the term combination rule or the entity naming rule to obtain the term sample or the entity sample.

3. The method according to claim 2, wherein the fine-grained sample refers to the word sample, the coarse-grained sample further comprises a phrase sample, and processing the fine-grained sample in each paragraph text to obtain the coarse-grained sample comprises:
detecting, based on the semantic meaning of each word sample and a structure of each word sample, whether all word samples in the current paragraph text conform to a phrase combination rule; and
combining, in response to detecting that a word sample in the current paragraph text conforms to the phrase combination rule, all word samples conforming to the phrase combination rule to obtain the phrase sample.

4. The method according to claim 1, wherein the fine-grained sample comprises a term sample or an entity sample, the coarse-grained sample comprises a phrase sample, and processing the fine-grained sample in each paragraph text to obtain the coarse-grained sample comprises:
acquiring semantic meanings and structures of all term samples or entity samples in each paragraph text;
detecting, based on a semantic meaning and structure of each term sample or entity sample, whether at least two adjacent term samples or entity samples in the current paragraph text conform to the phrase combination rule; and
combining, in response to detecting that the at least two adjacent term samples or entity samples in the current paragraph text conform to the phrase combination rule, all term samples or entity samples conforming to the phrase combination rule to obtain the phrase sample.

5. The method according to claim 1, wherein the fine-grained sample refers to a word sample, the coarse-grained sample comprises a phrase sample, and processing the fine-grained sample in each paragraph text to obtain the coarse-grained sample comprises:
acquiring the semantic meanings of the all word samples in each paragraph text and structures of the all word samples;
detecting, based on the semantic meaning of each word sample and the structure of each word sample, whether a preset number of adjacent word samples in the current paragraph text conform to the phrase combination rule in sequence; and
combining, in response to detecting that a plurality of word samples conforming to the phrase combination rule are present in the preset number of adjacent word samples in the current paragraph text, the plurality of word samples conforming to the phrase combination rule to obtain the phrase sample.

6. The method according to claim 1, wherein annotating the coarse-grained sample in each paragraph text and obscuring one coarse-grained sample using the mask of one fine-grained sample to obtain the training sample set comprises:
annotating content and a type of the coarse-grained sample in each paragraph text;
obscuring the coarse-grained sample in each paragraph text using a mask of a fine-grained sample corresponding to the fine-grained model, to obtain an annotated coarse-grained sample; and
sorting all fine-grained samples and all annotated coarse-grained samples according to an order of each fine-grained sample in a paragraph text of each fine-grained sample and an order of each coarse-grained sample in a paragraph text of each coarse-grained sample, to obtain the training sample set.

7. A method for predicting a text, comprising:
acquiring a to-be-predicted text; and
inputting the to-be-predicted text into a fine-grained model, to obtain a coarse grain size in the to-be-predicted text and a type of the coarse grain size, wherein the fine-grained model is generated through operations for training a model, and the operations comprise:
acquiring at least one paragraph text, each paragraph text comprising a plurality of fine-grained samples;
processing a fine-grained sample in each paragraph text to obtain a coarse-grained sample;
annotating the coarse-grained sample in each paragraph text and obscuring one coarse-grained sample using a mask of one fine-grained sample to obtain a training sample set, wherein the training sample set comprises a plurality of annotated texts, and each annotated text comprises at least one of: a fine-grained sample or an annotated coarse-grained sample; and
training a fine-grained model using the training sample set to obtain a trained fine-grained model, the fine-grained model being used to learn content of a previous fine grain size and predict content of an adjacent coarse grain size.

8. An electronic device, comprising:
at least one processor; and
a storage device, communicated with the at least one processor,
wherein the storage device stores one or more computer executable instructions, the one or more computer executable instructions, when executed by the at least one processor, cause the at least one processor to perform first operations for training a model or second operations for predicting a text;
the first operations comprise:
acquiring at least one paragraph text, each paragraph text comprising a plurality of fine-grained samples;
processing a fine-grained sample in each paragraph text to obtain a coarse-grained sample;
annotating the coarse-grained sample in each paragraph text and obscuring one coarse-grained sample using a mask of one fine-grained sample to obtain a training sample set, wherein the training sample set comprises a plurality of annotated texts, and each annotated text comprises at least one of: a fine-grained sample or an annotated coarse-grained sample; and
training a fine-grained model using the training sample set to obtain a trained fine-grained model, the fine-grained model being used to learn content of a previous fine grain size and predict content of an adjacent coarse grain size; and
the second operations comprise:
acquiring a to-be-predicted text; and
inputting the to-be-predicted text into the fine-grained model, to obtain a coarse grain size in the to-be-predicted text and a type of the coarse grain size, wherein the fine-grained model is generated through the first operations.

9. The device according to claim 8, wherein the fine-grained sample refers to a word sample, the coarse-grained sample comprises a term sample or an entity sample, and processing the fine-grained sample in each paragraph text to obtain the coarse-grained sample comprises:
acquiring semantic meanings of all word samples in each paragraph text;
detecting, based on a semantic meaning of each word sample, whether at least two adjacent word samples in a current paragraph text conform to a term combination rule or an entity naming rule; and
combining, in response to detecting that a combination of the at least two adjacent word samples conforms to the term combination rule or the entity naming rule, all word samples conforming to the term combination rule or the entity naming rule to obtain the term sample or the entity sample.

10. The device according to claim 9, wherein the fine-grained sample refers to the word sample, the coarse-grained sample further comprises a phrase sample, and processing the fine-grained sample in each paragraph text to obtain the coarse-grained sample comprises:
detecting, based on the semantic meaning of each word sample and a structure of each word sample, whether all word samples in the current paragraph text conform to a phrase combination rule; and
combining, in response to detecting that a word sample in the current paragraph text conforms to the phrase combination rule, all word samples conforming to the phrase combination rule to obtain the phrase sample.

11. The device according to claim 8, wherein the fine-grained sample comprises a term sample or an entity sample, the coarse-grained sample comprises a phrase sample, and processing the fine-grained sample in each paragraph text to obtain the coarse-grained sample comprises:
acquiring semantic meanings and structures of all term samples or entity samples in each paragraph text;
detecting, based on a semantic meaning and structure of each term sample or entity sample, whether at least two adjacent term samples or entity samples in the current paragraph text conform to the phrase combination rule; and
combining, in response to detecting that the at least two adjacent term samples or entity samples in the current paragraph text conform to the phrase combination rule, all term samples or entity samples conforming to the phrase combination rule to obtain the phrase sample.

12. The device according to claim 8, wherein the fine-grained sample refers to a word sample, the coarse-grained sample comprises a phrase sample, and processing the fine-grained sample in each paragraph text to obtain the coarse-grained sample comprises:
acquiring the semantic meanings of the all word samples in each paragraph text and structures of the all word samples;
detecting, based on the semantic meaning of each word sample and the structure of each word sample, whether a preset number of adjacent word samples in the current paragraph text conform to the phrase combination rule in sequence; and
combining, in response to detecting that a plurality of word samples conforming to the phrase combination rule are present in the preset number of adjacent word samples in the current paragraph text, the plurality of word samples conforming to the phrase combination rule to obtain the phrase sample.

13. The device according to claim 8, wherein annotating the coarse-grained sample in each paragraph text and obscuring one coarse-grained sample using the mask of one fine-grained sample to obtain the training sample set comprises:
annotating content and a type of the coarse-grained sample in each paragraph text;
obscuring the coarse-grained sample in each paragraph text using a mask of a fine-grained sample corresponding to the fine-grained model, to obtain an annotated coarse-grained sample; and
sorting all fine-grained samples and all annotated coarse-grained samples according to an order of each fine-grained sample in a paragraph text of each fine-grained sample and an order of each coarse-grained sample in a paragraph text of each coarse-grained sample, to obtain the training sample set.
